(19) United States
(12) Patent Application Publication
(10) Pub. No.: US 2008/0199196 A1
(43) Pub. Date: Aug. 21, 2008

(54) Machine Specific Transfer Bias Timing Adjustment

(76) Inventor: William Paul Cook, Lexington, KY (US)

Correspondence Address: John J. McArdle, Jr.;Lexmark International, Inc., Intellectual Property Department, 740 West New Circle Road, Lexington, KY, 40550, US

(21) Appl. No.: 11/675,126

(22) Filed: Feb. 15, 2007

(51) Int. Cl. G03G 15/16

(52) U.S. Cl. 399/66

(57) ABSTRACT

During a calibration procedure, a first duration between a leading edge trigger corresponding to a leading edge of the media sheet passing a known point in a media path and a feedback event indicating a media sheet in the transfer nip by changes in the transfer current caused by the impedance of the media sheet is calculated and stored. A second duration between a trailing edge trigger and a feedback event indicating no media sheet in the transfer nip may be calculated and stored. During a print operation, a controller delays by the first duration after a leading edge trigger and then increases the transfer voltage. The transfer voltage is decreased following a delay of the second duration after a trailing edge trigger. If the leading and trailing edge triggers occur at the same location along the media path, the first duration may be used for both delays,

### BACKGROUND

Certain image forming devices use an electrophotographic imaging process to develop toner images on a media sheet. The electrophotographic process uses electrostatic voltage differential to promote the transfer of toner from component to component. For example, a voltage vector may exist between a developer roll and a latent image on a photoconductive element. This voltage vector helps promote the transfer of toner from the developer roll to the latent image in a process that is sometimes called “developing the image.” A separate voltage vector may exist between the photoconductive element and a transfer member to promote the transfer of a developed image onto a substrate. In each instance, the toner transfer occurs in pad because, the toner itself is charged and is attracted to surfaces having an opposite charge or a lower potential.

The transfer voltage is set at the transfer member based upon known environmental conditions. In some image forming devices, the environmental conditions are detected with dedicated sensors. Other image forming devices transmit a signal through the interface between a transfer member and a photoconductive member. The electrical characteristics over this interface change in relation to environmental conditions. Thus, the measured electrical characteristics may be mapped in memory to environmental values or to actual operating parameters. For a certain detected reading, appropriate operating parameters, including the transfer voltage, may be set.

The transfer voltage is reduced between pages to avoid large charge buildup on the photoconductive member that cannot be recovered by the charge roller. In certain environments, the difference in transfer voltage during printing and between pages is significant. As a result, a large voltage transition occurs at each leading and trailing edge of a media sheet. The voltage steps should be aligned properly with the media entry and exit from the transfer nip. Incorrect timing may produce excessive current flow to or from the photoconductive member, resulting in a charge distribution on the photoconductive surface that may not be recovered by the charge roller. Consequently, print detects such as light or dark lines may appear on media sheets. Machine to machine mechanical tolerances are such that precise media sheet timing is not always predictable. Thus, the distance a media sheet travels within the device is not known with absolute precision. Therefore, a predetermined timing sequence may not work for all image forming devices in the same product line.

### SUMMARY

Embodiments of the present invention are directed to methods and devices for adjusting the transfer voltage transition timing in an image forming device. A leading edge trigger corresponds to a leading edge of the media sheet passing a known point in a media path upstream of a transfer nip. A feedback event indicates the presence or absence of a media sheet in the transfer flap due to changes in the transfer current caused by the impedance of the media sheet. During a calibration procedure, a first duration between a leading edge trigger and a feedback event indicating a media sheet in the transfer nip is calculated and stored. A second duration between a trailing edge trigger and a feedback event indicating no media sheet in the transfer nip may be calculated and stored. During a print operation, a controller delays by the first duration after a leading edge trigger and then increases the transfer voltage, corresponding to the arrival at the transfer nip of a media sheet leading edge. The transfer voltage is decreased following a delay of the second duration after a trailing edge trigger. If the leading and trailing edge triggers occur at the same location along the media path, the first duration may be used for both delays.

### BRIEF DESCRIPTION OF THE DRAWINGS

FIG. 1 is a functional block diagram of an image forming device according to one embodiment;

FIG. 2 is a cross-sectional view of an image forming unit and associated power supply and transfer feedback circuit according to one embodiment;

FIG. 3 is a timing diagram of a calibration procedure using leading and trailing edge triggers to correct transfer voltage transition timing according to one or more embodiments:

FIG. 4 is a flow diagram of the calibration procedure of FIG. 3;

FIG. 5 is a timing diagram of a calibration procedure using only leading edge triggers to correct transfer voltage transition timing according to one or more embodiments, and

FIG. 6 is a flow diagram of the calibration procedure of FIG. 5.

### DETAILED DESCRIPTION

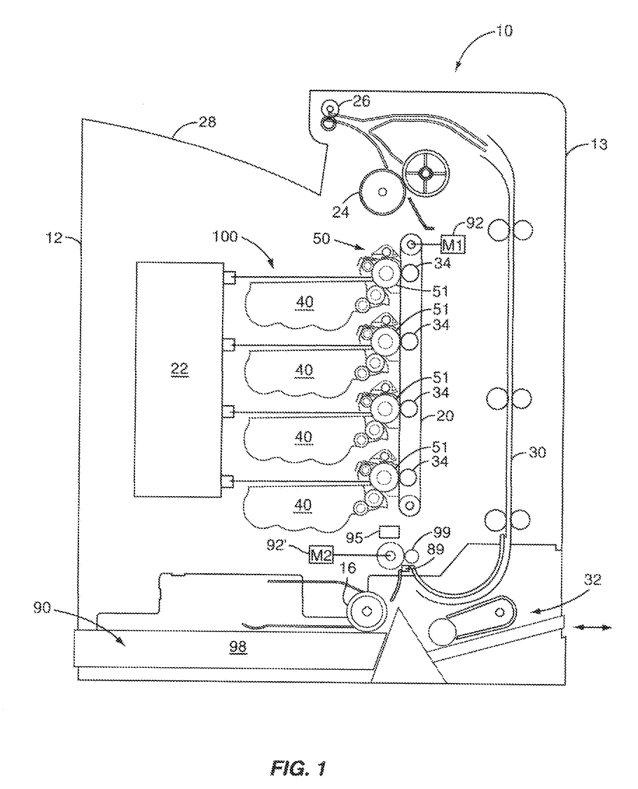

Embodiments disclosed herein are directed to devices and related methods to adjust media edge (leading/trailing) timing events based on the results of a calibration procedure in which actual edge timing is determined. These embodiments may be applicable in a device that uses an electrophotographic imaging process such as the representative image forming device 10 shown in FIG. 1. The exemplary image forming device 10 comprises a main body 12 and a door assembly 13 A media tray 98 with a pick mechanism 16, and a multi-purpose feeder 32, are conduits for introducing media sheets 90 into the device 10. The media tray 98 is preferably removable for refilling, and located on a lower section of the device 10.

Media sheets 90 are moved from the input and fed into a primary media path. In one embodiment, a sensor 89 detects the presence of media sheets 90. One or more registration rollers 99 disposed along the media path aligns the print media and precisely controls its further movement along the media path. A media transport belt 20 forms a section of the media path for moving the media sheets 90 past a plurality of image forming units 100. Media sheet 90 feed motion is provided by one or more motors 92, 92′.

In one implementation, a media sheet 90 is pulled from the media tray and forwarded through the sensor 89 to the registration rollers 99, which are initially held fixed or run in reverse. At some predetermined time later, the registration rollers 99 rotate under the influence o f motor M2 92′ to move the media sheet 90 towards the image forming units 100. Because of mechanical tolerances, the precise distance a media sheet 90 travels from the media tray 98, to the registration rollers 99, and to the image forming units 100 is unknown. Thus, the timing at which transfer voltages are applied and adjusted may be off slightly. In one embodiment, the image forming device 10 uses a sensor 95 to detect the presence or absence of a media sheet along the media path between the registration rollers 99 and the image forming units 100,

An optical scanning device 22 forms a latent image on a photoconductive member 51 within the image forming units 100. The latent image is developed using toner supplied by a developer unit 40 and the developed image is subsequently transferred onto a media sheet that is carried past the photoconductive member 51 by a transport belt 20. Color printers typically include four image forming units 100 for printing with cyan, magenta, yellow, and black toner to produce a four-color image on the media sheet 90. The media sheet 90 with loose toner is then moved through a fuser 24 to fix the toner to the media sheet 90. Exit rollers 26 rotate in a forward direction to move the media sheet 90 to an output tray 28, or rollers 26 rotate in a reverse direction to move the media sheet 90 to a duplex path 30. The duplex path 30 directs the inverted media sheet 90 back through the image formation process for forming an image on a second side of the media sheet 90.

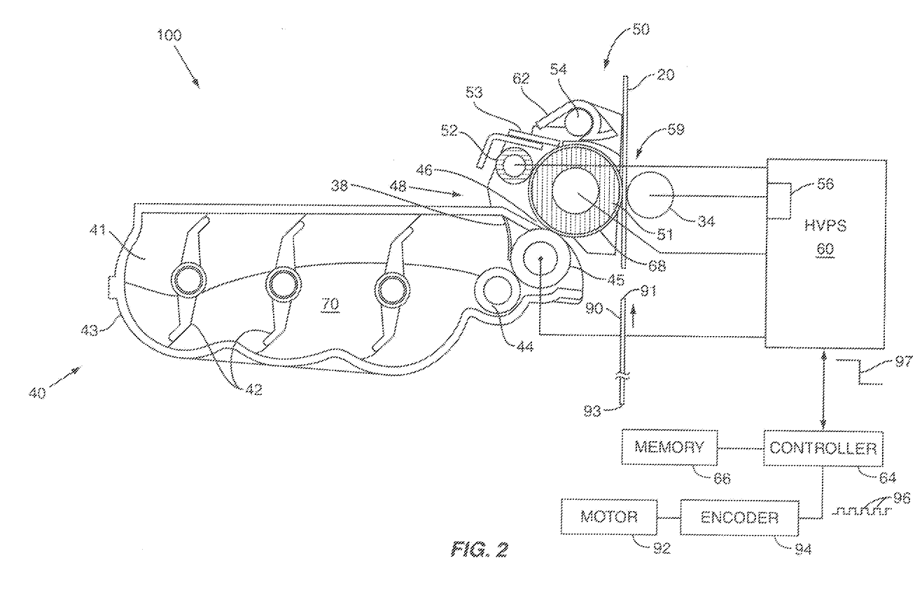

As illustrated in FIGS. 1 and 2, the image forming units 100 are comprised of a developer unit 40 and a photoconductor (PC) unit 50. The developer unit 40 comprises an exterior housing 43 that forms a reservoir 41 for holding a supply of toner 70. One or more agitating members 42 are positioned within the reservoir 41 for agitating and moving the toner 70 towards a toner adding roll 44 and the developer member 45. The developer unit 40 further comprises a doctor element 38 that controls the toner 70 layer formed on the developer member 45. In one embodiment, a cantilevered, flexible doctor blade as shown in FIG. 2 may be used. Other types of doctor elements 38, such as spring-loaded, ingot style doctor elements may be used. The developer unit 40 and PC unit 50 are structured so the developer member 45 is accessible for contact with the photoconductive member 51 at a nip 46. Consequently, the developer member 45 is positioned to develop latent images formed on the photoconductive member 51.

The exemplary PC nit 50 comprises the photoconductive member 51 a charge roller 52, a cleaner blade 53, and a waste toner auger 54 all disposed within a housing 62 that is separate from the developer unit housing 43. In one embodiment, the photoconductive member 51 is an aluminum hollow-core drum with a photoconductive coating 68 comprising one or more layers of light-sensitive organic photoconductive materials. The photoconductive member 51 is mounted protruding from the PC unit 50 to contact the developer member 45 at nip 46. Charge roller 52 is electrified to a predetermined bias by a high voltage power supply (HVPS) 60 that is adjusted or turned on and off by a controller 64. The charge roller 52 applies an electrical charge to the photoconductive coating 68. During image creation, selected portions of the photoconductive coating 68 are exposed to optical energy, such as laser light, through aperture 48. Exposing areas of the photoconductive coating 68 in this manner creates a discharged latent image on the photoconductive member 51. That is, the latent image is discharged to a lower charge level than areas of the photoconductive coating 68 that are not illuminated.

The developer member 45 (and hence, the toner 70 thereon) is charged to a bias level by the HVPS 60 that is advantageously set between the bias level of charge roller 52 and the discharged latent image. In one embodiment, the developer member 45 is comprised of a resilient (e.g., foam or rubber) roller disposed around a conductive axial shaft. Other compliant and rigid roller-type developer members 45 as are known in the art may be used. Charged toner 70 is carried by the developer member 45 to the latent image formed on the photoconductive coating 68. As a result of the imposed bias differences, the toner 70 is attracted to the latent image and repelled from the remaining, higher charged portions of the photoconductive coating 68. At this point in the image creation process, the latent image is said to be developed.

The developed image is subsequently transferred to a media sheet 90 being carried past the photoconductive member 51 by media transport belt 20. In the exemplary embodiment, a transfer roller 34 is disposed behind the transport belt 20 in a position to impart a contact pressure at the transfer nip 59. In addition, the transfer roller 34 is advantageously charged, typically to a polarity that is opposite the charged toner 70 and charged photoconductive member 51 to promote the transfer of the developed image to the media sheet 90.

The cleaner blade 53 contacts the outer surface of the photoconductive coating 68 to remove toner 70 that remains on the photoconductive member 51 following transfer of the developed image to a media sheet 90. The residual toner 70 is moved to a waste toner auger 54. The auger 54 moves the waste toner 70 out of the photoconductor unit 50 and towards a waste toner container (not shown), which may be disposed of once full.

In one embodiment, the charge roller 52, the photoconductive member 51, the developer member 45, the doctor element 38 and the toner adding roll 44 are all negatively biased. The transfer roller 34 may be positively biased to promote transfer of negatively charged toner 70 particles to a media sheet 90. Those skilled in the art will comprehend that an image forming unit 100 may implement polarities opposite from these.

Periodically such as between print jobs or at the start of a print job, the HVPS 60, under the control of controller 64, implements a transfer servo routine to determine a transfer servo voltage (“TSV”) that varies in relation to changing operating conditions. The printer controller 64 may adjust operating parameters (e.g., bias voltage applied to the transfer roller 34 or the fuser 24 temperature shown in FIG. 1 based on the determined TSV to compensate for changes in operating conditions, including temperature and humidity.

In one embodiment, the TSV that produces a predetermined current through the transfer roller 34 is determined. Other embodiments may consider a current that produces a predetermined voltage. In the illustrated embodiment, the HVPS 60 includes a sensing circuit 56 adapted to sense the voltage transmitted to the transfer roller 34 that produces a target current of 8 μA. This sensing circuit 56 produces a state change (i.e., low to high transition, otherwise referred to as a positive feedback, in a binary output signal 97 that is sensed by the controller 64 when the transfer current equals or exceeds the target current of 8 μA. If the transfer current remains below the target current, the output signal 97 of the sensing circuit 56 remains low. The target current of 8 μA is greater than the typical current during printing, so the sensing circuit 56 typically remains low. If a lower target current were used or a higher voltage were required during printing, the sensing circuit could go high during printing, with no detrimental effects

In the exemplary configuration shown and described, the applied current travel,s through various components, including the transfer roller 34, the media transport belt 20, the photoconductive member 51 and ultimately to ground. Some of the applied current may also travel to ground via the cleaner blade 53, charge roller 52, and/or developer member 45. The voltage that produces the target current is referred to as the “transfer servo voltage” or “TSV” The value of the TSV is transmitted to or otherwise determined by the controller 64. In one embodiment, operating parameters are mapped in memory 66 to different values of the TSV. The controller 64 reads the operating parameter for a measured TSV and, in turn, sets appropriate operating parameters for subsequent printing. FIG. 1 shows that there are four image forming units 100 in the representative image forming device. Accordingly, the process of determining the TSV may be performed for each transfer location in the image forming device 10. In one embodiment, the process is performed simultaneously at each image forming unit 100. Alternatively, the process may be performed sequentially at each image forming unit 10.

Separate from the transfer servo routine, but using many of the same components, circuitry, and processing steps, a calibration routine may be executed to identify machine-specific leading edge 91 and trailing edge 93 timing for media sheets. Actual edge timing should be known as this timing may vary for each image forming device. For example, the distance between registration rollers 99 and an image forming unit 100 may vary from machine to machine. Once the edge timing is known, the controller 64 may accurately time the transition from print transfer voltage levels to inter-page (IP) voltage levels. The calibration routine uses information on the velocity of motors 92, 92′ used to transport the media sheet 90 from the registration rollers 99 (see FIG. 1) and through the transfer nips 59. Motor 92, 92′ speed may be determined using conventionally known techniques, including frequency generators or using pulses 96 from a motor encoder 94.

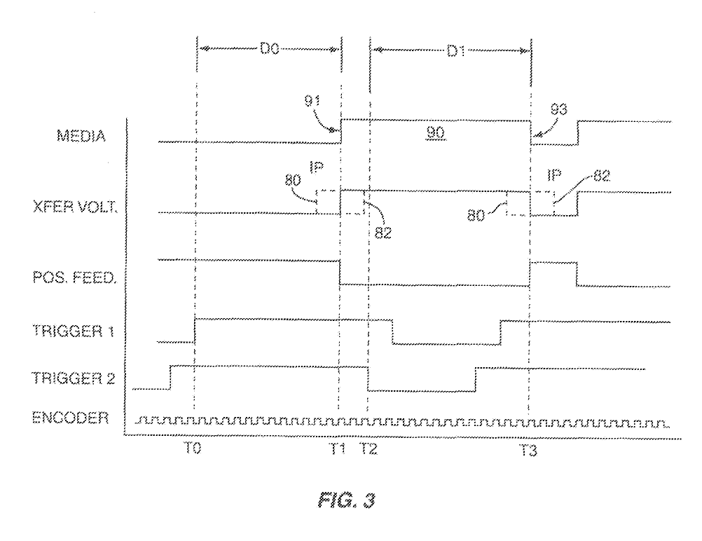

FIG. 3 depicts a timing diagram illustrating various events considered during the calibration procedure, according to one embodiment. The upper MEDIA line represents the period of time for which a media sheet 90 is present in the transfer nip 59. That is, the MEDIA line is HI when a media sheet 90 is in the transfer nip 59 and LO during the IP region. The XFER VOLT line represents transfer voltage transitions that should correspond substantially with the media sheet edge timing. For example, at time T1, when a leading edge 91 of a media sheet 90 enters the nip 59, the transfer voltage should transition to an increased print level. Conversely, at time T3, when a trailing edge 93 of a media sheet 90 exits the transfer nip 59, the transfer voltage should transition to a decreased IP level.

The TRIGGER1 line represents a trigger event at which the position of a leading edge 91 of a media sheet 90 is known. In one embodiment, the TRIGGER1 line goes high When a motor 92′ actively rotates a registration roller 99 in the forward direction to advance a media sheet 90. In this embodiment, the registration roller 99 is held stationary, or runs slowly in reverse, while a media sheet 90 is fed from the media tray 98, and is then rotated forward to move the media sheet 90 towards the image forming units 100 Accordingly, at the moment the motor 92′ begins to rotate in a forward direction, the leading edge 91 of the media sheet 90 passes through the registration rollers 99.

The TRIGGER1 transition at time TO represents a leading edge (LE) TRIGGER event that may used as a starting point for measuring durations that correspond to distances along the media path. For example, time duration D0 may represent the time that elapses between the LE TRIGGER event at time T0 and the time at which the leading edge 91 enters the transfer nip 59. The LE TRIGGER event at time T0 may include a leading edge 91 passing a known location such as the registration roller 99. The time D0 may correspond to a distance between a registration roller 99 and a transfer nip 56.

The TRIGGER2 line corresponds to the output of sensor 89. In particular, the TRIGGER2 line goes high when a leading edge 91 of a media sheet enters the sensor 89, and goes low when a trailing edge 93 of the media sheet exits the sensor 89. The trailing edge (TE) TRIGGER event at time T2 represents a trailing edge 93 of a media sheet 90 passing the sensor 89. The time duration D1 may represent the time that elapses between the LE TRIGGER event at time T2 and the time at which the trailing edge 93 enters the transfer nip 59.

Due to mechanical tolerance variations, a nominal transfer voltage timing may actually induce voltage transition early (as indicated by dashed line 80) or late (dashed line 82) relative to the actual leading 91 and trailing 93 edge events at T1 and 13 To correct for these variations, a calibration procedure may be executed periodically, or as needed, to bring the transfer voltage transitions into substantial alignment with the media edge events.

In one embodiment, the calibration procedure, may be a user-initiated option that is initiated at a user interface panel (not shown) of the image forming device 10. In one embodiment, the calibration procedure is performed after a predetermined period of time or a predetermined number of printed pages. In one embodiment, the calibration procedure is performed after image formation components such as a photoconductive member 51, transport belt 20, or other rollers or motors are replaced. The calibration procedure may be implemented automatically, or through a command requesting that the user initiate the procedure.

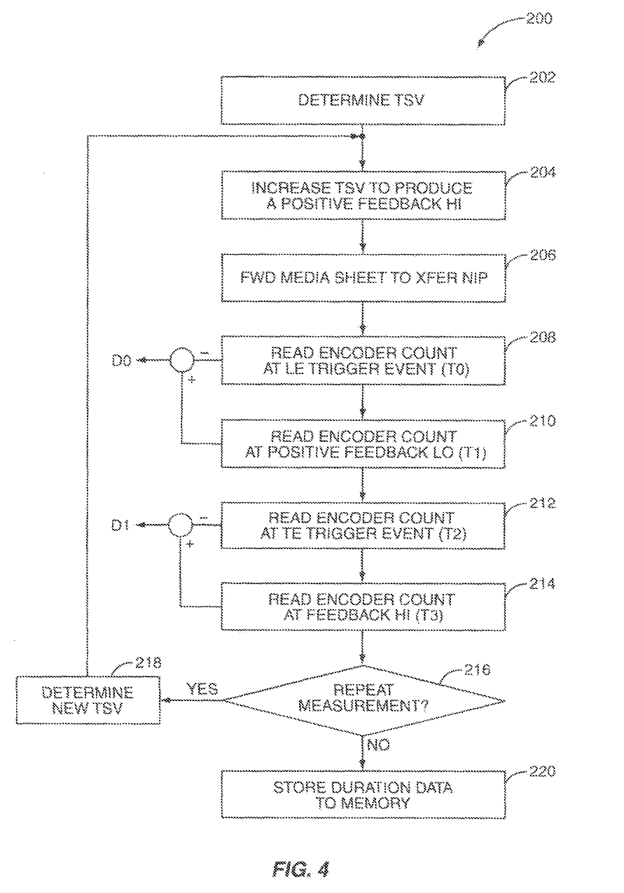

The flow diagram o f FIG. 4 broadly illustrates a calibration procedure 200 according to one or more embodiments represented by the timing diagram of FIG. 3. Initially, at step 202, the controller 64 determines the TSV as would be performed normally to identify environmental conditions. A transfer servo routine identifies the TSV that produces a predetermined current through the transfer servo loop shown in FIG. 2. A detected current in excess of the predetermined current will produce a HI value in a positive feedback signal 97 sensed by the controller 64. Next, at step 204, the controller nominally increases the transfer voltage to guarantee that the positive feedback signal 97 will remain HI as long as there is no media sheet 90 in the transfer nip. The positive feedback signal 97 is identified as POS. FEED, in the timing diagram in FIG. 3.

At step 206, a first media sheet 90 is forwarded towards the transfer nip 59. At step 208, the controller 64 reads or tracks a motor count, for example, by beginning to track encoder pulses 96 from a motor 92′ and/or encoder 94. This initial reading corresponds to the LE TRIGGER event at time T0 Also, the motor count may be taken from a motor 92 that is used to move the media sheet 90 along the media path. This may include a motor 92′ driving a registration roller, a motor 92 driving a transport belt, a motor driving a photoconductive member 51, or other motor in the image forming device 10 whose speed and/or position may be determined by the controller 64.

As the media sheet 90 enters the transfer nip 59 at time T1, the current flow across the nip decreases due to the relatively high resistance in the media sheet. The positive feedback signal 97 falls to a LO level because the detected current across the transfer nip 59 is below the predetermined value. The controller 64 uses this HI to LO transition as an indication of when the media sheet 90 has entered the nip 59. At step 210, the controller 64 reads the motor count. At this point, the difference in the counts obtained at steps 208 and 210 define the duration D0 representing the time that elapses between the leading edge trigger event at time T0 and a leading edge 91 of a media sheet 90 entering the transfer nip 59 at time T1. This value may be stored for later reference,

At the TE TRIGGER at time T2—corresponding to the trailing edge 93 of the media sheet 90 exiting the sensor 89—the controller 64 again reads the motor count at step 212. As a trailing edge 93 of the media sheet 90 exits the nip 59 at time T3, the current flow across the transfer nip 59 increases because the resistive media sheet is no longer present in the transfer nip 59. The positive feedback signal 97 rises to a HI level because the detected current across the transfer nip 59 is above the predetermined value (due to the elevated transfer voltage set in step 204). The controller 64 uses this LO to HI transition as an indication that the media sheet 90 has exited the nip. At step 214, the controller 64 reads the motor count as described above. At this point, the difference in the counts obtained at steps 212 and 214 identify the duration D1 representing the elapsed time between the trailing edge 93 leaving the sensor 89 and leaving the transfer nip 59. The value of D1 may be saved.

As well known in the art, the results of most measurement procedures follow a Gaussian distribution, or “bell curve,” wherein most results differ relatively little, with a few results showing a greater variation. The deleterious effect of such variations on the accuracy of the overall calibration procedure may be mitigated by repeating the calibration measurements and averaging the results. Accordingly, the flow diagram of FIG. 4 depicts a decision step 216 that terminates a loop in which the above-described calibration procedure is repeated.

If it is determined at step 216 to perform an additional measurement, the transfer servo voltage may be updated at step 218 by running the transfer servo routine again to identify the TSV that produces a p redetermined current through the transfer servo loop. The new TSV may be different from the previous iteration determined at step 202 due to capacitive effects in the transfer servo loop. The controller 64 determines an accurate value for the TSV so as to once again guarantee that the positive feedback signal 97 remains high in the IP region. Control then returns to step 204, where the controller 64 increments the TSV to push the positive feedback signal 97 HI, and another media sheet 90 is forwarded towards the transfer nip 59 Steps 204-214 are repeated and new values for D0 and D1 are obtained and stored, in one embodiment, the controller 64 may monitor the values D0 and D1 for abnormal results, such as when readings from a single iteration vary from a nominal or expected result by more than a predetermined percentage. These types of errors may occur due to media pick errors or jams.

At step 216, once sufficient calibration iterations have been performed, the values D0 and D1 from the iterations may be averaged, and the average, values stored to non-volatile memory 220 for use during subsequent print operations. In one embodiment, the controller 64 may store the timing information as deviations from a nominal or expected timing. Thus, in subsequent print jobs, the controller 64 may advance or delay a hard coded timing based upon the values stored in memory 66.

Referring back to FIGS. 1-3, the operation of the image forming device 10 during normal print operations is described. A media sheet 90 is picked from the media tray 98 or inserted into the multi-purpose feeder 32, and moves along the media path. After receiving a LE TRIGGER provided by the forward motion of the registration roller 99 at time T0, the controller 64 waits the duration D0 determined from the most previous calibration procedure 200, and increases the transfer voltage at time T1, substantially corresponding to the arrival of the leading edge 91 of the media sheet 90 at the transfer nip 59. Similarly, after receiving a TE TRIGGER provided by the media sensor 89 at time T2, the controller 64 waits the duration D1 and decreases the transfer voltage at time T3, substantially corresponding to the departure of the trailing edge 93 of the media sheet 90 from the transfer nip 59. Note that the controller does not need to know the length of the media sheet 90.

Note that in the case of a longer media path between the registration roller 99 and/or sensor 89 and the transfer nip 59, the events T1 and T2 may occur in the opposite order of that depicted in FIG. 3. In this case, the calibration steps 210 and 212 in FIG. 4 will also occur in the opposite order. However, this does not affect the calibration procedure 200 or print operation room as described above.

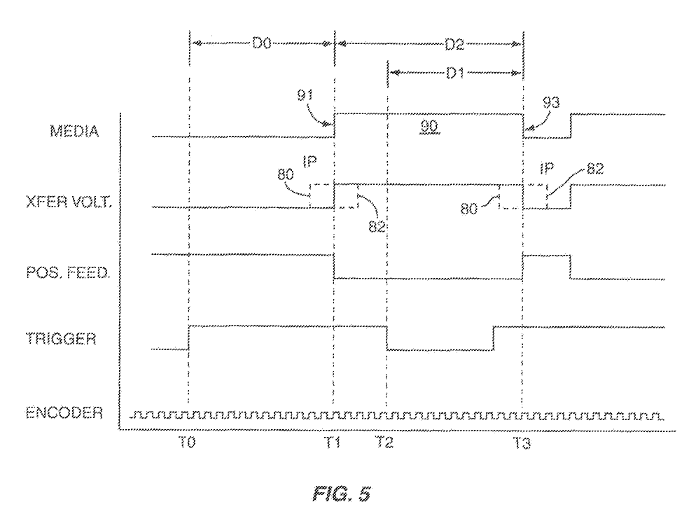

FIG. 5 depicts a timing diagram for an embodiment of an image forming device 10 having a single paper sensor 95 in the media path downstream of the registration rollers 99. This embodiment may find particular utility in image forming devices 10 where the registration roller 99 is constantly driven in a forward direction. In various embodiments, the sensor 95 may provide only a LE TRIGGER, both a LE TRIGGER and TE TRIGGER, or only a TE TRIGGER with the LE TRIGGER provided by the registration rollers 99.

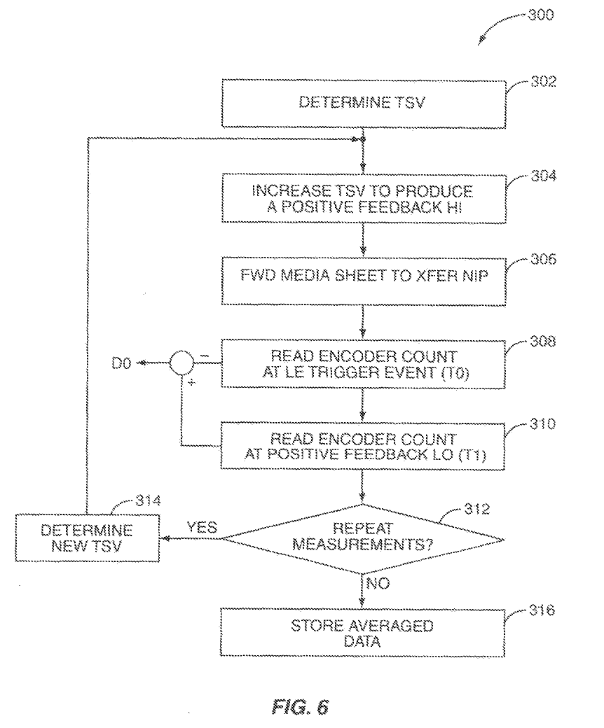

The flow diagram of FIG. 6 depicts the steps in a calibration procedure 300 using only a single LE TRIGGER. The controller 64 determines a TSV at step 302, and increases the TSV slightly to produce a positive feedback signal 97 at step 304. A media sheet 90 is moved towards the transfer nip 59 at step 306. In response to a LE TRIGGER from the sensor 95 at T0, the controller 64 reads a motor count, or begins counting encoder pulses, at step 308. When the leading edge 91 of the media sheet 90 enters the transfer nip 59 at T1 the increased resistance reduces the transfer current, causing a HI to LO transition in the positive feedback signal 97. In response, the controller 64 again reads a motor count at step 310, and calculates and stores the duration D0 as the difference between the motor counts at steps 308 and 310.

If the calibration procedure 300 is to be repeated at step 312, a new TSV is set at step 314, and control returns to step 304. If sufficient iterations of the procedure 300 have been performed at step 312, the values of D0 are averaged and stored to non-volatile memory at step 316.

Referring again to FIG. 5, during print operations, the controller 64 detects the LE TRIGGER provided by the sensor 95 at T0. Following the duration D0 determined during the most recent calibration procedure 300, the controller 64 increases the transfer voltage at time T1, as the leading edge 91 of the media sheet 90 enters the transfer nip 59. The controller 64 then detects a TE TRIGGER provided by the sensor 95 at T2. If the media sheet 90 is traveling at a constant speed (and assuming the media sheet 90 does not change in length), the duration between the TE TRIGGER, and the trailing edge 93 exiting the transfer nip 59—depicted as duration D1 in FIG. 5—is the same as D0 with a fixed adjustment for any sensor hysteresis. Accordingly, the controller 64 counts D0 motor encoder pulses after the TE TRIGGER at T2 and reduces the transfer voltage at T3, as the trailing edge 93 exits the transfer nip at 59.

As an alternative, those of skill in the art will readily recognize that, during printing, the controller 64 may calculate the length of a media sheet 90 (the duration D2 in FIG. 5) directly from the LE TRIGGER at T0 and TE TRIGGER at T1 from sensor 95. The controller 64 may then use the LE TRIGGER at T0 and duration D0 to increase the transfer voltage at T1, and then simply count P2 motor pulses before decreasing the transfer voltage at T3.

In still another embodiment, the controller 64 may take as a LE TRIGGER the initial forward motion of the registration rollers 99, and take a signal from the sensor 95 as the TE TRIGGER. In this embodiment, the timing diagram of FIG. 3 and flow diagram of FIG. 4 apply, with the registration roller 99 motion as TRIGGER1 and the sensor 95 output as TRIGGER2, with the exception that the TRIGGER2 edges would fie to the right of the TRIGGER1 edges as the sensor 95 is downstream of the registration rollers 99 in the media path.

Those skilled in the art should also appreciate that the control circuitry associated with controller 64 shown in FIG. 2 for implementing the present invention may comprise hardware, software, or any combination thereof. For example, circuitry for initiating, performing, and adjusting the transfer feedback voltage may be a separate hardware circuit, or may be included as part of other processing hardware. More advantageously, however, the processing circuitry in these devices is at least partially implemented via stored computer program instructions for execution by one or more computing devices, such as microprocessors, Digital Signal Processors (DSPs), ASICs or other digital processing circuits included in the controller 64. The stored program instructions may be stored in electrical, magnetic, or optical memory devices, such ROM and RAM modules, flash memory, hard disk drives, magnetic disc drives, optical disc drives and other storage media known in the art.

Spatially relative terms such as “under”, “below”, “lower”, “over”, “upper” and the like, are used for ease of description to explain the positioning of one element relative to a second element. These terms are intended to encompass different orientations of the device, in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. For instance, the transfer nip described herein represents an example of a primary transfer nip where images are transferred directly from a photoconductive member 51 to a media sheet 90. In other image forming devices., an intermediate transfer belt is used to transfer an image twice, including once from the photoconductive member 51 to the belt and once from the belt to a media sheet 90. The timing corrections provided herein are certainly appropriate at a secondary transfer nip used in this Hatter type of image forming device. The present embodiments are, therefore, to be considered in all respects as illustrative and not restrictive, and all changes coming within the meaning and equivalency range of the appended claims are intended to be embraced therein.

What is claimed is:

1. A method of adjusting the transfer voltage transition timing in an image forming device comprising, during a calibration procedure:
forwarding a media sheet along a media path towards an image transfer nip;
sensing a leading edge trigger, at which a leading edge of the media sheet is at a known position along the media path;
sensing a first feedback event, at which the leading edge of the media sheet enters the transfer nip,
calculating a first duration between the leading edge trigger and the first feedback event; and
storing the first duration.

2. The method of claim 1 wherein the leading edge trigger comprises the initial forward motion of a registration roller in the media path.

3. The method of claim 1 wherein the leading edge trigger comprises a signal from a media sheet sensor in the media path.

4. The method of claim 1 wherein the first feedback event comprises a transition in a signal indicative of a change in impedance across the transfer nip, caused by the presence of the media sheet in the transfer map.

5. The method of claim 1 wherein calculating the first duration comprises counting motor encoder pulses associated with a media path motor between the leading edge trigger and the first feedback event.

6. The method of claim 1 further comprising determining a transfer servo voltage producing a predetermined current across the transfer nip prior to the first feedback event.

7. The method of claim 6 further comprising setting the transfer voltage to a predetermined offset from the determined transfer servo voltage prior to the first feedback event.

8. The method of claim 1 further comprising, during a print operation:
retrieving the stored first duration;
forwarding a media sheet along a media path towards the transfer nip;
sensing the leading edge trigger, and
after a delay corresponding to the first duration, increasing the transfer voltage across the transfer nip.

9. The method of claim 8 further comprising, during the print operation:
sensing a trailing edge trigger, at which a trailing edge of the media sheet is at the same known position along the media path as the leading edge was at the leading edge event; and
after a delay corresponding to the first duration, decreasing the transfer voltage across the transfer nip.

10. The method of claim 1 further comprising, during the calibration procedure:
sensing a trailing edge trigger, at which a trailing edge of the media sheet is at a known position along the media path,
sensing a second feedback event, at which the trailing edge of the media sheet exits the transfer nip;
calculating a second duration between the trailing edge trigger and the second feedback event; and
storing the second duration.

11. The method of claim 10 further comprising, during a print operation:
retrieving the stored first and second durations;
forwarding a media sheet along a media path towards the transfer nip;
sensing the leading edge trigger;
after a delay corresponding to the first duration, increasing the transfer voltage across the transfer nip;
sensing the trailing edge trigger; and
after a delay corresponding to the second duration, decreasing the transfer voltage across the transfer nip.

12. An electrophotographic image forming device comprising:
an image transfer nip located along a media path through the image forming device;
a power supply operative to apply a variable transfer voltage across the transfer nip;
a sensing circuit in the power supply operative to sense the transfer voltage that produces a predetermined current through the transfer nip, and further operative to output a binary threshold signal that changes state as the current lags or, exceeds the predetermined current;
a position reporting element disposed at a known position along the media path upstream of the transfer nip and operative to generate a leading edge trigger as a leading edge of a media sheet moves past the position reporting element towards the transfer nip;
a controller operative during a calibration procedure to calculate a first duration that elapses between the leading edge trigger and a transition in the threshold signal caused by a change in the transfer nip current due to the impedance of the media sheet entering the transfer nip; and
memory accessible by the controller and operative to store the first duration.

13. The device of claim 12 wherein the position reporting element comprises a registration roller and wherein the leading edge trigger comprises the initial rotation of the registration roller in the direction of the transfer nip.

14. The device of claim 12 wherein the position reporting element comprises a media sheet sensor.

15. The device of claim 12 wherein the controller is further operative during a print operation to read the first duration from memory, receive a leading edge trigger, and after a delay corresponding to the first duration, to increase the transfer voltage.

16. The device of claim 15 wherein the controller is further operative during the print, operation to receive from the position reporting element a leading edge trigger indicating a trailing edge of a media sheet at the position reporting element t, and after a delay corresponding to the first duration, to decrease the transfer voltage.

17. The device of claim 12 wherein
the position reporting element is further operative to generate a trailing edge trigger as a trailing edge of a media sheet moves past the position reporting element; and
the controller is further operative during the calibration procedure to calculate a second duration that elapses between the trailing edge trigger and a transition in the threshold signal caused by a change in the transfer nip current due to the media sheet exiting the transfer nip; and
the memory is further operative to store the second duration.

18. The device of claim 17 wherein the controller is further operative during a print operation to read the second duration from memory, receive a trailing edge trigger, and after a delay corresponding to the second duration, to decrease the transfer voltage.

19. A method of adjusting transfer voltage transition timing, comprising:
performing a calibration procedure to calculate and store at least a first duration between a leading edge of the media sheet passing a known position along a media path and the media sheet entering a transfer nip as detected by a change in transfer nip current due to the impedance of the media sheet; and
during a print operation, detecting the leading edge of the media sheet at the known position and, after a delay corresponding to the first duration, increasing the transfer voltage.

20. The method of claim 19, further comprising during a print operation, detecting a trailing edge of the media sheet at the known position and, after a delay corresponding to the first duration, decreasing the transfer voltage.
